(19) United States
(12) Patent Application Publication
(10) Pub. No.: US 2022/0405076 A1
(43) Pub. Date: Dec. 22, 2022

(54) DETECTING AND DEPLOYING SYSTEM RESOURCE COMPATIBLE UPDATE PACKAGES

(71) Applicant: Dell Products L.P., Round Rock, TX (US)

(72) Inventors: Trinto Thattil Nadakkalan Antony, Thrissur (IN); Vivekanandh Narayanasamy Rajagopalan, Bangalore (IN)

(21) Appl. No.: 17/350,344

(22) Filed: Jun. 17, 2021

(51) Int. Cl. G06F 8/65; G06F 8/71; G06F 8/61; G06F 9/50

(52) U.S. Cl. CPC G06F 8/65; G06F 8/71; G06F 8/61; G06F 9/5016; G06F 9/5027

(57) ABSTRACT

System resource compatible update packages can be detected and deployed. An update package's update metadata can include a system resource compatibility profile. Prior to installing an update package, an update tool on an end user device can evaluate the end user device's system resource information against the update package's system resource compatibility profile. If the system resource information does not comply with the update package's system resource compatibility profile, the update tool can forego installing the update package. In this way, the update package can ensure that otherwise compatible update packages are not installed because their installation may reduce the performance of the end user device.

### CROSS-REFERENCE TO RELATED APPLICATIONS

N/A

### BACKGROUND

End user devices, such as laptops, desktops, tablets, smart phones, etc., need to be updated to maintain security and to take advantage of new features. Updates are oftentimes obtained and installed on end user devices via the operating system (e.g., Microsoft's Windows Update) or via an original equipment manufacturer's (OEM's) update system/tool (e.g., Dell's SupportAssist or HP's Support Assistant), but many additional techniques are also used.

In many cases, updates are deployed in the form of an update package. An update package may typically be associated with (or include) metadata for the update (“update metadata”). For example, update packages for Windows-based drivers may be associated with an INF file that defines the update metadata for the driver update and update packages for Windows UWP applications may be associated with an app package manifest that defines the update metadata for the UWP application update. Update metadata for a variety of update packages may also be defined in catalogs, such as Microsoft System Center Update catalogs or Dell catalogs. Notably, in this context, an update may result in a modification to an already installed component (e.g., updating existing firmware, an existing driver or an existing application) or in the installation of a new component (e.g., installing new firmware, a new driver or a new application whether or not the installation replaces an existing component).

Regardless of how it may be defined for and/or associated with an update package, the update metadata for an update package may define criteria for determining whether the update package applies to a particular end user device. Such criteria may include an identification of a particular system (e.g., an indication that an update package containing a firmware update or application update applies to a particular line of laptops), an identification of a particular hardware component (e.g., an indication that an update package containing a driver update applies to end user devices having a particular graphics card, network card, memory card reader, etc.) and/or an identification of a particular operating system (e.g., an indication that an update package is only applicable to end user devices running a particular version of an operating system). The primary function of such criteria is to ensure that update packages are only installed on end user devices with which the update is compatible (e.g., to avoid installing a driver for a particular hardware device on an end user device that does not include the particular hardware device). Installing incompatible update packages can degrade the end user device's performance and, in some cases, may prevent the end user device from operating.

Although this currently-used criteria is effective in preventing the installation of incompatible updates, various problems still arise. For example, even though an update package may be compatible with an end user device, the installation of the update package may not improve or may even degrade the performance of the end user device.

### BRIEF SUMMARY

The present invention extends to methods, systems, and computer program products for detecting and deploying system resource compatible update packages. An update package's update metadata can include a system resource compatibility profile. Prior to installing an update package, an update tool on an end user device can evaluate the end user device's system resource information against the update package's system resource compatibility profile. If the system resource information does not comply with the update package's system resource compatibility profile, the update tool can forego installing the update package. In this way, the update package can ensure that otherwise compatible update packages are not installed because their installation may reduce the performance of the end user device.

In some embodiments, the present invention may be implemented as a method for detecting and deploying system resource compatible update packages. Update metadata for a first update package can be accessed. It can then be determined that the update metadata for the first update package includes a first system resource compatibility profile. The system resource information for an end user device can be compared to the first system resource compatibility profile. In response to determining that the system resource information for the end user device complies with the first system resource compatibility profile, the first update package can be installed on the end user device.

In some embodiments, update metadata for a second update package may be accessed. It can be determined that the update metadata for the second update package includes a second system resource compatibility profile. The system resource information for the end user device can be compared to the second system resource compatibility profile. In response to determining that the system resource information for the end user device does not comply with the second system resource compatibility profile, the second update package can be prevented from being installed on the end user device.

In some embodiments, the present invention may be implemented as an end user device that includes system resources, such as memory and a CPU, and an update tool. The update tool can access update metadata for a first update package. The update tool can determine that the update metadata for the first update package includes a first system resource compatibility profile. The update tool can compare system resource information for the end user device to the first system resource compatibility profile. In response to determining that the system resource information for the end user device complies with the first system resource compatibility profile, the update tool can install the first update package on the end user device.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which the present invention can be implemented;

FIG. 2 provides an example of an update tool that can be employed on end user devices;

FIG. 3 provides examples of how system resource compatibility profiles may be defined in update metadata for update packages;

FIG. 4 provides an example of how system resource compatibility profiles may be refined; and

FIGS. 5A-5F provide an example of how an update tool may use system resource compatibility profiles to determine whether to install update packages on an end user device.

### DETAILED DESCRIPTION

The term “update package” should be construed as a collection of one or more files that are delivered when an update is installed. For example, in a Windows environment, an update package for a driver would typically include each driver file (e.g., one or more .sys files), each installation file (e.g., one or more INF files) and a catalog (.cat) file that represents the digital signature of the package. An update package for firmware may include the payload for a firmware update that can be distributed to the hardware via the Unified Extensible Firmware Interface (“UEFI”). An update package for an application may include the application's executable and any dependencies. In some embodiments, an update package may be in the form of an .exe file, an .appx file, an .msu file, a .cab file or any of the other file types that are or may be used to deploy updates to end user devices.

The term “update metadata” should be construed as metadata that is used to define whether an update package is compatible with or intended for a particular end user device. The term “catalog” should be construed as a collection of update metadata defining update packages that are intended for a particular end user device. For example, a catalog may be in the form of an .xml file that identifies characteristics of the targeted end user devices and lists all of the update packages that are intended for the targeted end user devices. Embodiments of the present invention encompass scenarios where a catalog is used to define update metadata but also encompass any other way to associate update metadata with an update package.

In accordance with embodiments of the present invention, update metadata for an update package can include or be associated with a system resource compatibility profile. The system resource compatibility profile can then be used to detect and deploy system resource compatible update packages on an end user device. Embodiments of the present invention can ensure that an update package that is otherwise compatible with an end user device will not be installed on the end user device if doing so would violate the system resource compatibility profile. In this way, the performance of an end user device can be preserved.

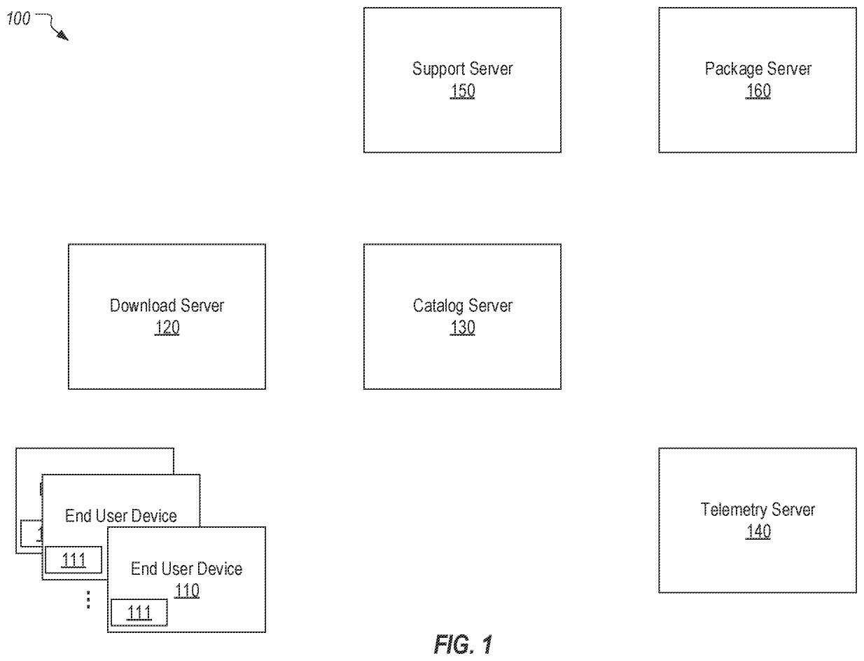

FIG. 1 illustrates one example computing environment 100 in which embodiments of the present invention may be implemented. Computing environment 100 includes a number of end user devices 110, a download server 120, a catalog server 130, a telemetry server 140, a support server 150 and a package server 160. In this context, the term “server” should be construed as representing any suitable arrangement of hardware and/or software components that would enable the functionality described herein to be accomplished. The depiction of each server being separate is for illustrative purposes only. For example, in some embodiments, some or all of the depicted servers could be implemented within the same cloud architecture, whereas, in other embodiments, each depicted server could be implemented on a separate computing device. In short, the present invention should not be limited to any particular architecture but should encompass the described functionality that can be implemented in a wide variety of architectures.

End user devices 110 may typically represent desktops, laptops, tablets, smart phones or other personal computing devices to which update packages can be deployed to install/update components such as firmware, drivers and applications. In a common example, end user devices 110 could represent a group or all of a particular OEM's (e.g., Dell's or HP's) end user devices. As shown, an update tool 111 can be installed on end user devices 110. Update tool 111 can be configured to retrieve and install update packages on end user device 110 as well as other functionality as described below. In some embodiments, update tool 111 could represent an OEM-provided tool (e.g., Dell's SupportAssist or HP's Support Assistant), an operating-system-provided tool (e.g., Windows Update) or any other update tool.

Download server 120 can represent the components in computing environment 100 that enable update tool 111 to download (or otherwise retrieve) update packages for installation on end user devices 110. As an example only, download server 120 could encompass the components that implement the downloads.dell.com website and corresponding back-end services. Catalog server 130 can represent the components in computing environment 100 that create and maintain catalogs. For example, catalog server 130 could maintain a catalog that includes update metadata for all update packages that are intended for a particular group of end user devices 110, while download server 120 could provide access to these update packages.

In any case, the manner in which update tool 111 obtains update packages and update metadata is not essential to the present invention.

Telemetry server 140 can represent the components in computing environment 100 that receive telemetry data from update tool 111. In some embodiments, this telemetry data could represent the performance and system resources of end user devices 110 on which an update package has been installed, and telemetry server 140 could use the telemetry data to create, modify or refine a system resource compatibility profile for the update package. However, in some embodiments, telemetry server 140 may not be involved in creating, modifying or refining any system resource compatibility profiles.

Support server 150 can represent the components in computing environment 100 that implement end-user support services. As an example only, support server 150 could encompass the support.dell.com website and corresponding back-end services. Package server 160 can represent the components in computing environment 100 that store update packages received from providers. As examples only, providers such as Dell, Intel, AMD, Realtek, Qualcomm, etc. may deliver update packages to package server 160 so that the update packages can be distributed to end user devices 110 via download server 120.

Computing environment 100 is intended to provide context for some embodiments only and should not be viewed as the only computing environment in which embodiments of the present invention may be implemented. For example, system resource compatibility profiles could be leveraged in any OEM-specific update environment, the Windows Update environment, the Windows App Store environment or any other operating-system-provided update environment.

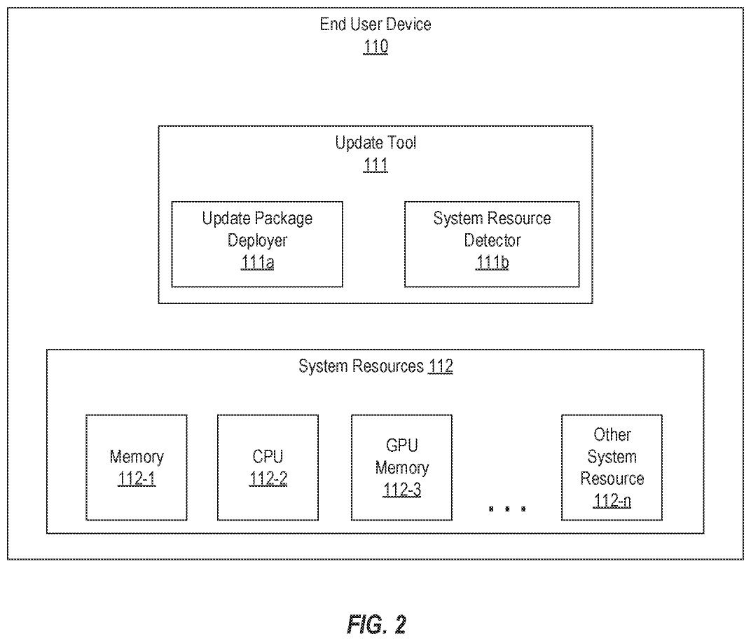

FIG. 2 provides an example of how update tool 111 may be configured in some embodiments of the present invention. Update tool 111 can include an update package deployer 111a and a system resource detector 111b. Update package deployer 111a can be configured to identify update packages that are compatible with (or intended for) the end user device 110 on which it is running. For example, in some embodiments, update package deployer 111a could download (or otherwise access) update metadata for an update package (e.g., by downloading the update metadata possibly with the update package from download server 120). In some embodiments, update package deployer 111a may download a catalog applicable to the end user device 110 on which it is running and evaluate the update metadata defined in the catalog for multiple update packages.

In accordance with embodiments of the present invention, in addition to identifying update packages that are compatible with end user device 110, update package deployer 111a may also determine whether end user device 110′s system resources comply with a system resource compatibility profile included in the update metadata for each update package. Update tool 111 may include a system resource detector 111b that update package deployer 111a can leverage for this purpose. For example, system resource detector 111b can be configured to identify characteristics of system resources 112 such as an amount of memory 112-1, a frequency of CPU 112-2, an amount of GPU memory 112-3, etc. System resource detector 111b can employ any available technique on end user device 110 to obtain this information about system resources 112 (hereinafter “system resource information”).

System resource detector 111b can provide the system resource information to update package deployer 111a. Then, prior to installing an otherwise compatible update package on end user device 110, update package deployer 111a can compare the system resource information for end user device 110 with a system resource compatibility profile included in the update metadata for the update package. If the system resource information does not comply with the system resource compatibility profile, update package deployer 111a can forego installing the update package on end user device 110. In this way, update tool 111 can prevent the installation of an update package that may degrade the performance of end user device 110.

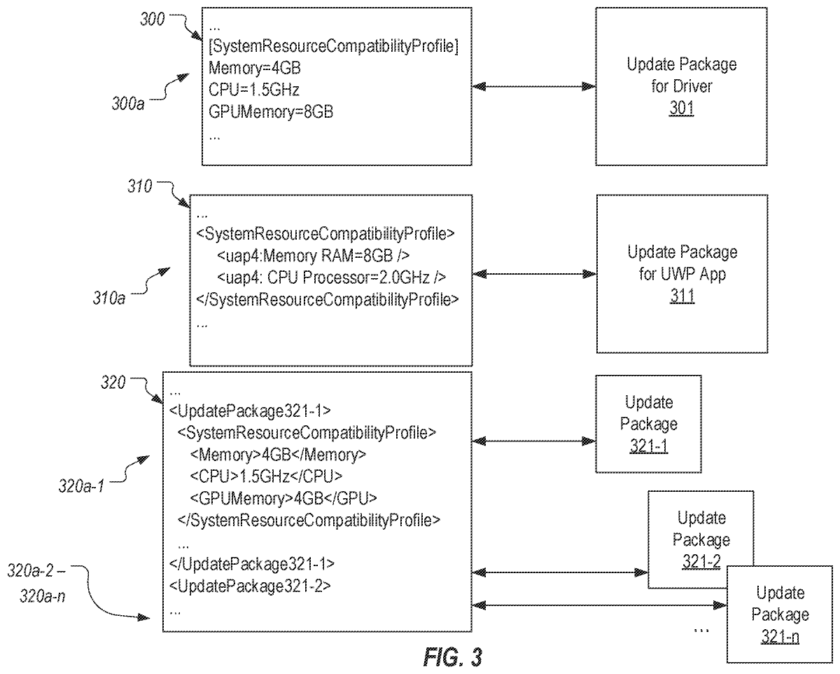

FIG. 3 provides various examples of how a system resource compatibility profile may be included in/with update metadata for one or more update packages. In a first example, update metadata 300 (e.g., an INF) for an update package 301 for a driver may include a system resource compatibility profile 300a. In a second example, update metadata 310 (e.g., a UWP app manifest) for an update package 311 for a UWP app may include a system resource compatibility profile 310a. In a third example, update metadata 320 (e.g., a catalog) for a plurality of update packages 321-1 through 321-n may include a system resource compatibility profile 320a-1 through 320a-n for each of update packages 321-1 through 321-n.

System resource compatibility profile 300a indicates that update package 301 should only be installed on an end user device 110 if the end user device 110 has at least 4 GB of memory, a CPU frequency of at least 1.5 GHz and at least 8 GB of GPU memory. System resource compatibility profile 310a indicates that update package 311 should only be installed on an end user device 110 if the end user device 110 has at least 8 GB of memory and a CPU frequency of at least 2.0 GHz. System resource compatibility profile 320a indicates that update package 321-1 should only be installed on an end user device 110 if the end user device 110 has at least 4 GB of memory, a CPU frequency of at least 1.5 GHz and at least 4 GB of GPU memory. In some embodiments, which is assumed to be the case in FIG. 3, update metadata in the form of a catalog could include a separate system resource compatibility profile for each update package defined in the catalog. However, in other embodiments, a single system resource compatibility profile may be defined in a catalog and may apply to all the update packages defined in the catalog or to a group of the update packages defined in the catalog. In other words, there need not be a one-to-one relationship between an update package and a system resource compatibility profile. Also, memory, CPU frequency and GPU memory are only some examples of the type of system resources information that may be included in a system resources compatibility profile.

A system resource compatibility profile could be included in/with update metadata in a variety of ways. In some embodiments, the provider of the update package could specify the system resource compatibility profile. For example, a provider of an update package for updating an application or driver could define a system resource compatibility profile to prevent the application or driver from being updated on an end user device 110 that may not have the system resources to adequately support the update. In such embodiments, the system resource compatibility profile could be added to the update metadata for the update package (e.g., by integrating it into a catalog, manifest, INF, etc.).

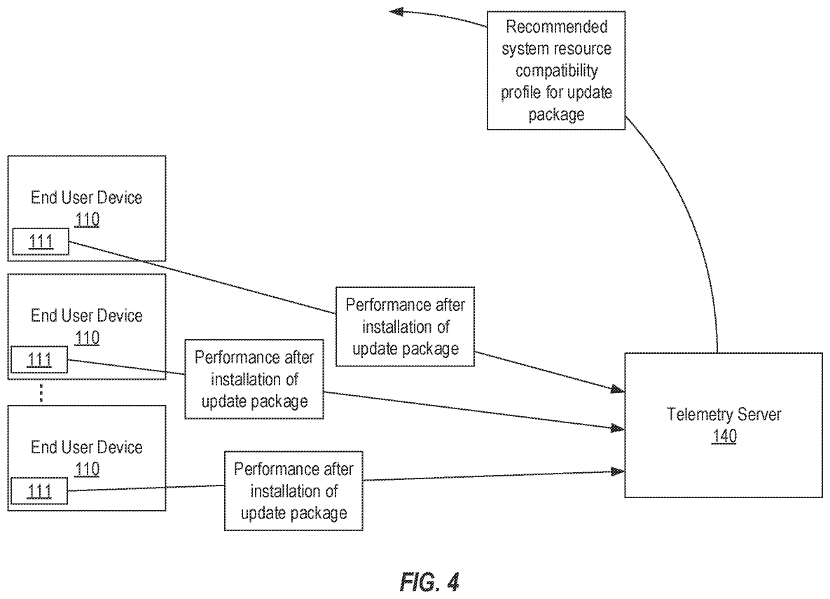

In some embodiments, such as is represented in FIG. 4, update tool 111 may be configured to monitor system performance after installation of an update package and to relay telemetry information representing such performance to telemetry server 140. In such embodiments, telemetry server 140 may use the reported performance to recommend a system resource compatibility profile for the update package (if one had not yet been defined) or updates to the system resource compatibility profile (if one has been defined). The recommended system resource compatibility profile can then be included in the update metadata in future deployments of the update package.

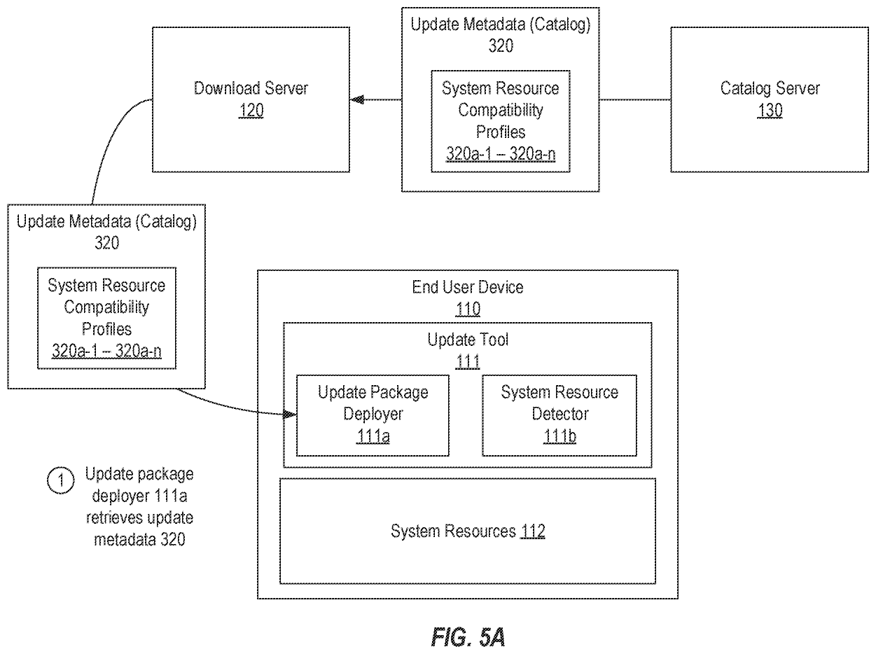

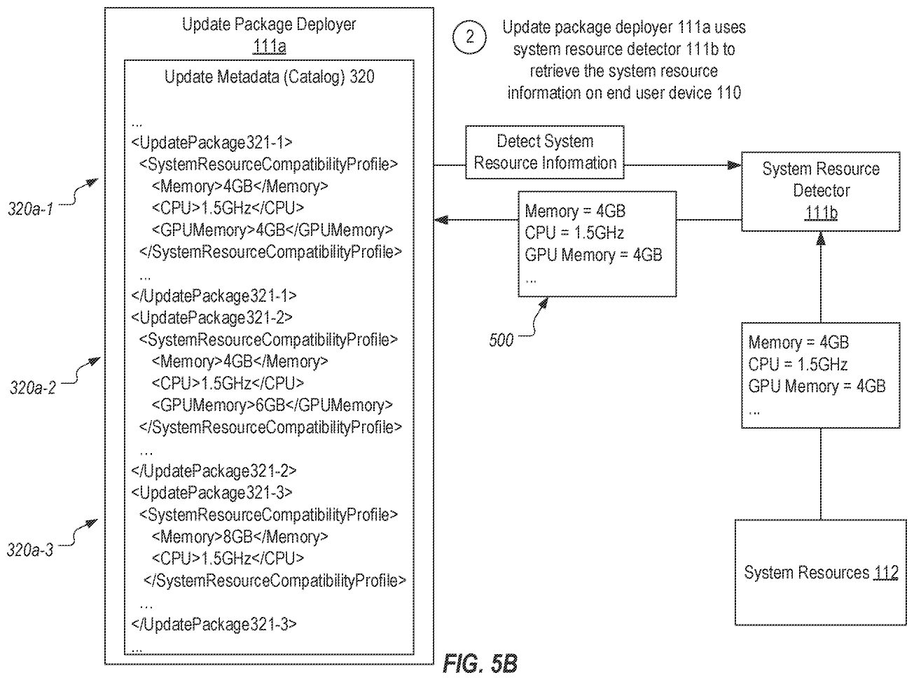

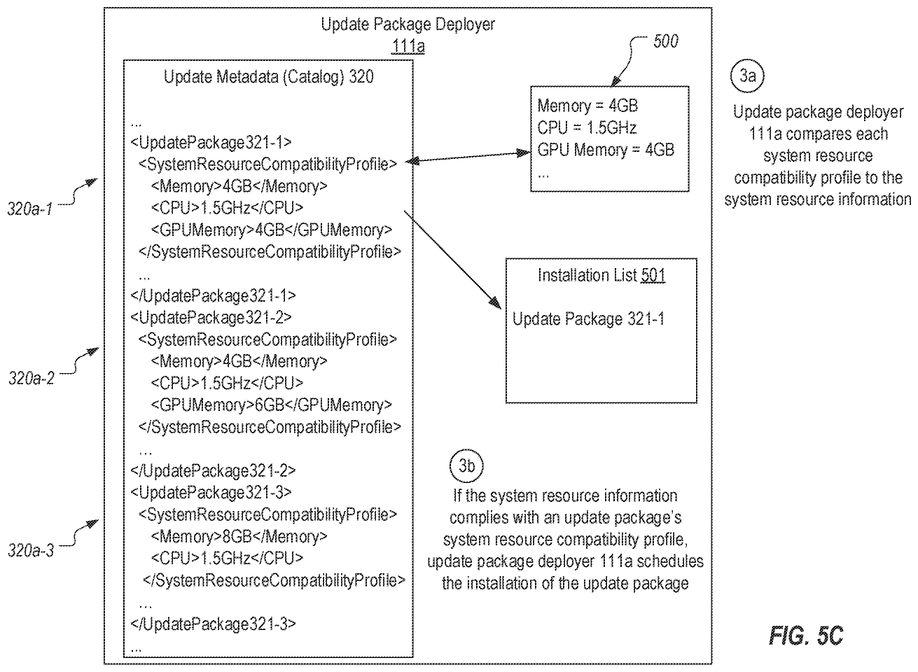

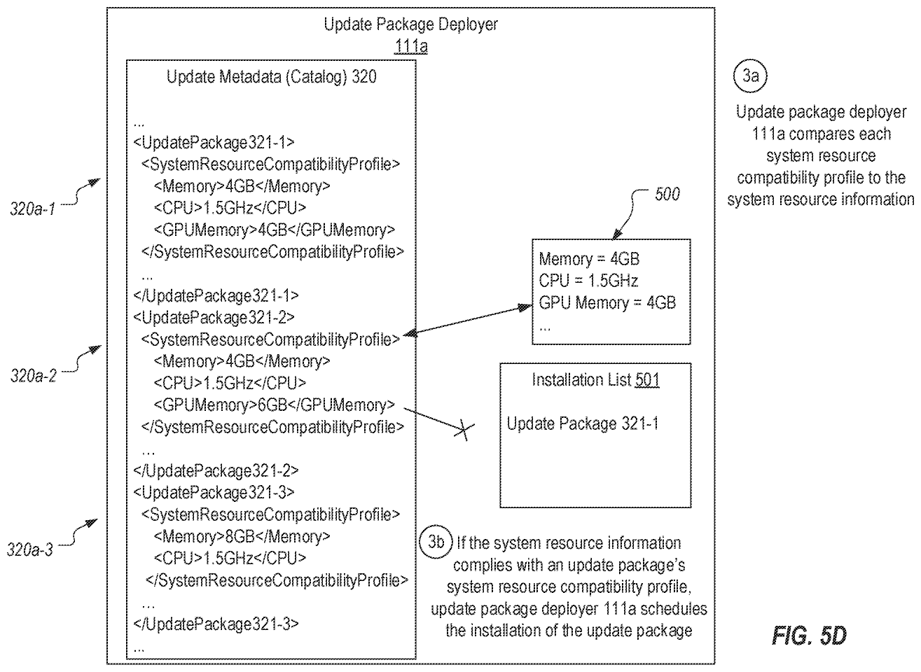

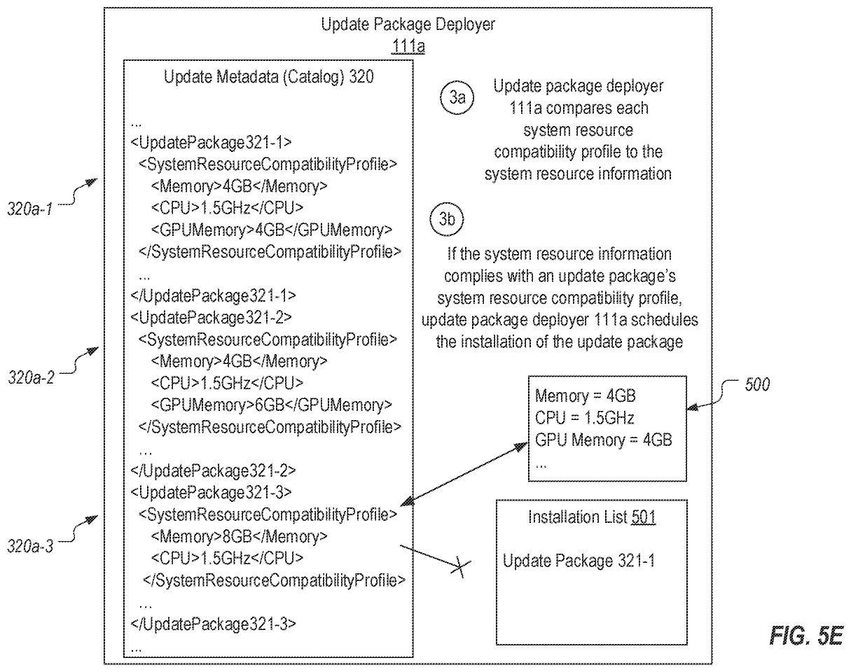

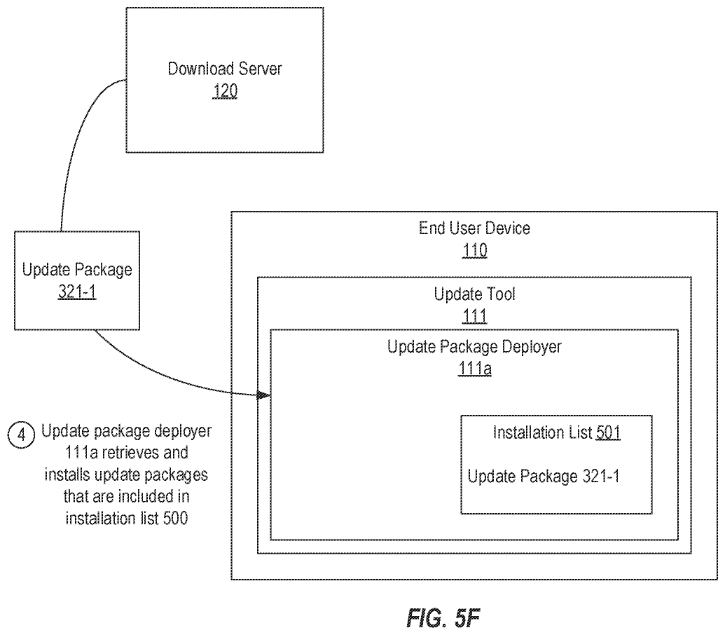

FIGS. 5A-5F provide an example of how update tool 111 can employ a system resource compatibility profile to determine whether to install an update package on end user device 110. In FIG. 5A, it is assumed that catalog server 130 maintains update metadata 320 in the form of a catalog and that update metadata 320 includes system resource compatibility profiles 320a-1 through 320a-n corresponding to update packages 321-1 through 321-n. It is also assumed that catalog server 130 provides update metadata 320 (and possibly many other catalogs/update metadata) to download server 120 for access by update tool 111 on end user devices 110.

In step 1, it is assumed that update package deployer 111a obtains update metadata 320 from download server 120 as part of an update process. For example, update tool 111 could be configured to periodically obtain the current version of the catalog applicable to end user device 110 on which it is running, or update tool 111 may obtain the current version of the catalog in response to user input.

Turning to FIG. 5B, in step 2, which may be performed in response to obtaining update metadata 320 or at an earlier time, update package deployer 111a can use system resource detector 111b to retrieve system resource information on end user device 110. For example, system resource detector 111b could use any available technique to detect that end user device 110 has 4 GB of memory, a CPU frequency of 1.5 GHz and 4 GB of GPU memory among possibly other types of system resource information, and could then provide this system resource information 500 to update package deployer 111a. FIG. 5B also shows that, for this example, catalog 320 is assumed to define system resource compatibility profiles 320a-1 through 320a-3 for update packages 321-1 through 321-3 respectively.

Turning to FIGS. 5C-5E, once update package deployer 111a has obtained update metadata 320 and system resource information 500, in step 3a, update package deployer 111a can evaluate each update package's system resource compatibility profile against system resource information 500. In step 3b, if the system resource information complies with an update package's system resource compatibility profile, update package deployer 111a can schedule the installation of the update package (or otherwise allow/cause it to be installed on end user device 110).

For example, FIG. 5C represents that, in step 3a, update package deployer 111a compares system resource compatibility profile 320a-1 to system resource information 500. Because system resource information 500 complies with system resource compatibility profile 320a-1 (i.e., because system resource information 500 indicates that end user device 110 has 4 GB of memory, a CPU frequency of 1.5 GHz and 4 GB of GPU memory), in step 3b, update package deployer 111a may add update package 321-1 to an installation list 501.

In contrast, FIG. 5D represents that, in step 3a, update package deployer 111a compares system resource compatibility profile 320a-2 to system resource information 500. Because system resource information 500 does not comply with system resource compatibility profile 320a-2 (i.e., because system resource information 500 indicates that end user device 110 does not have 6GB of GPU memory), in step 3b, update package deployer 111a may forego adding update package 321-2 to installation list 501.

Similarly, FIG. 5E represents that, in step 3a, update package deployer 111a compares system resource compatibility profile 320a-3 to system resource information 500. Because system resource information 500 does not comply with system resource compatibility profile 320a-3 (i.e., because system resource information 500 indicates that end user device 110 does not have 8 GB of memory), in step 3b, update package deployer 111a may forego adding update package 321-3 to installation list 501.

Update package deployer 111a could perform steps 3a and 3b for each update package identified in update metadata 320, or more particularly, for each update package for which update metadata 320 includes a system resource compatibility profile. Therefore, after performing steps 3a and 3b, installation list 501 may include any update package that is identified in update metadata 320 and that has a system resource compatibility profile with which end user device 110's system resource information 500 complies.

Turning to FIG. 5F, in step 4, update package deployer 111a can retrieve and install each update package that is included in installation list 501. For example, assuming that only update package 321-1 was added to installation list 501, update package deployer 111a could download update package 321-1 from download server 120 and cause it to be installed on end user device 110 while foregoing the installation of update packages 321-2 and 321-3 even though they are intended for and otherwise compatible with end user device 110.

In some embodiments, update tool 111 may provide an option for an end user to override update package deployer 111a's decision to forego installation of an update package. For example, in some embodiments, when update package deployer 111a determines that system resource information 500 does not comply with the system resource compatibility profile for a particular update package, update package deployer 111a could present a notification to the end user informing him or her that system resources do not comply with the system resource compatibility profile for the particular update package. In conjunction with presenting this notification, update package deployer 111a could also provide an option that the end user could select to cause the particular update package to still be installed. For example, if the end user selects the option, update package deployer 111a could add the particular update package to installation list 501 or otherwise cause it to be installed.

Although FIGS. 5A-5F represent an example that uses update metadata in the form of a catalog, a similar process can be performed when the update metadata is defined in other ways. For example, update package deployer 111a could obtain an update package for a driver which includes an INF containing the system resource compatibility profile. In such a case, update package deployer 111a could evaluate the system resource compatibility profile defined in the INF against the system resource information and only proceed with the installation of the driver if the system resource information complies with the system resource compatibility profile. A similar process could also be performed when an update package for an application or other component becomes available for installation.

Accordingly, embodiments of the present invention enable an update tool to selectively deploy update packages based on whether an end user device's system resources are compatible with defined system resource compatibility profiles. In this way, update packages that target the end user device and are otherwise compatible with the end user device's configuration can be prevented from being installed to thereby avoid degrading performance.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

1. A method for detecting and deploying system resource compatible update packages, the method comprising:
obtaining, on an end user device, a first update package that is compatible with the end user device;
accessing update metadata for the first update package;
determining that the update metadata for the first update package includes a first system resource compatibility profile defining one or more of an amount of memory, a frequency of a CPU, or an amount of GPU memory that the end user device is recommended to have to maintain performance of the end user device after installation of the first update package;
comparing system resource information for the end user device to the first system resource compatibility profile; and
in response to determining that the system resource information for the end user device complies with the first system resource compatibility profile, causing the first update package to be installed on the end user device.

2. The method of claim 1, further comprising:
accessing update metadata for a second update package;
determining that the update metadata for the second update package includes a second system resource compatibility profile;
comparing the system resource information for the end user device to the second system resource compatibility profile; and
in response to determining that the system resource information for the end user device does not comply with the second system resource compatibility profile, preventing the second update package from being installed on the end user device.

3. The method of claim 2, wherein the update metadata for the first update package and the update metadata for the second update package are defined in a catalog.

4. The method of claim 2, wherein the system resource information includes one or more of:
an amount of memory of the end user device;
a frequency of a CPU of the end user device; or
an amount of GPU memory of the end user device.

5. The method of claim 2, wherein the system resource information includes an amount of memory of the end user device and a frequency of a CPU of the end user device.

6. The method of claim 2, further comprising:
notifying an end user that the second update package was prevented from being installed on the end user device;
receiving input from the end user requesting installation of the second update package; and
in response to the input, causing the second update package to be installed.

7. The method of claim 1, wherein the update metadata is defined in a driver INF file or an application manifest.

8. The method of claim 1, wherein determining that the system resource information for the end user device complies with the first system resource compatibility profile comprises determining that the system resource information meets or exceeds the first system resource compatibility profile.

9. The method of claim 1, wherein obtaining the first update package comprises downloading the first update package.

10. The method of claim 1, wherein the first update package contains a driver update, an application update or a firmware update.

11. The method of claim 1, further comprising:
monitoring performance of the end user device after the first update package is installed; and
based on the monitored performance, adjusting the first system resource compatibility profile.

12. One or more computer storage media storing computer executable instructions which when executed implement a method for detecting and deploying system resource compatible update packages, the method comprising:
obtaining, on an end user device, a first update package that is compatible with the end user device;
accessing update metadata for the first update package;
determining that the update metadata for the first update package includes a first system resource compatibility profile defines an amount of memory, a frequency of a CPU, and an amount of GPU memory that the end user device is recommended to have to maintain performance of the end user device after installation of the first update package;
comparing system resource information for the end user device including an amount of memory, a frequency of a CPU, and an amount of GPU memory that the end user device has to the first system resource compatibility profile; and
in response to determining that the system resource information for the end user device complies with the first system resource compatibility profile, causing the first update package to be installed on the end user device.

13. The computer storage media of claim 12, wherein the method further comprises:
accessing update metadata for a second update package;
determining that the update metadata for the second update package includes a second system resource compatibility profile;
comparing the system resource information for the end user device to the second system resource compatibility profile; and
in response to determining that the system resource information for the end user device does not comply with the second system resource compatibility profile, preventing the second update package from being installed on the end user device.

14. The computer storage media of claim 13, wherein the update metadata for the first update package and the update metadata for the second update package are defined in a catalog.

15. (canceled)

16. The computer storage media of claim 13, wherein the method further comprises:
notifying an end user that the second update package was prevented from being installed on the end user device;
receiving input from the end user requesting installation of the second update package; and
in response to the input, causing the second update package to be installed.

17. The computer storage media of claim 12, wherein determining that the system resource information for the end user device complies with the first system resource compatibility profile comprises determining that the system resource information meets or exceeds the first system resource compatibility profile.

18. An end user device comprising:
system resources comprising memory, a CPU, and GPU memory; and
an update tool that is configured to perform a method for detecting and deploying system resource compatible update packages, the method comprising:
obtaining a first update package that is compatible with the end user device;
accessing update metadata for the first update package;
determining that the update metadata for the first update package includes a first system resource compatibility profile defining an amount of memory, a frequency of a CPU, and an amount of GPU memory that the end user device is recommended to have to maintain performance of the end user device after installation of the first update package;
comparing system resource information for the end user device to the first system resource compatibility profile; and
in response to determining that the system resource information for the end user device complies with the first system resource compatibility profile, causing the first update package to be installed on the end user device.

19. The end user device of claim 18, wherein the method performed by the update tool further comprises:
accessing update metadata for a second update package;
determining that the update metadata for the second update package includes a second system resource compatibility profile;
comparing the system resource information for the end user device to the second system resource compatibility profile; and
in response to determining that the system resource information for the end user device does not comply with the second system resource compatibility profile, preventing the second update package from being installed on the end user device.

20. The end user device of claim 19, wherein the system resource information comprises an amount of the memory of the end user device, a frequency of the CPU of the end user device, and an amount of GPU memory of the end user device.
